(19) United States
(12) Patent Application Publication
(10) Pub. No.: US 2019/0303808 A1
(43) Pub. Date: Oct. 3, 2019

(54) Ticket Verification

(71) Applicant: Tikkit, Inc., New York, NY (US)

(72) Inventors: Dominic Konstam, New York, NY (US); Atlas Wegman, New York, NY (US)

(21) Appl. No.: 16/368,991

(22) Filed: Mar. 29, 2019

Related U.S. Application Data
(60) Provisional application No. 62/649,797, filed on Mar. 29, 2018.

(51) Int. Cl. G06Q 10/02; G06Q 20/40; G06Q 30/06; G06Q 20/04; H04W 76/10

(52) U.S. Cl. CPC G06Q 10/02; G06Q 20/40; G07C 9/00103; G06Q 20/045; H04W 76/10; G06Q 30/0633

(57) ABSTRACT

A method of electronic ticket verification, including positioning a host device, including a screen, a host input interface, and a wireless network adapter, at an access point to a venue at an event time, verifying, by tap verification, an electronic ticket, wherein tap verification includes establishing a wireless connection between the host device and a client device, receiving gesture input through the host input interface, receiving by the host device an attribute of a client electronic ticket from the client device over the wireless network adapter, and searching a ticket data for the received attribute.

### CROSS-REFERENCE TO RELATED APPLICATIONS

This application is a utility application claiming the benefit of priority to U.S. Provisional Application No. 62/649,797, entitled “Ticket Verification,” filed on Mar. 29, 2018. The entire contents and disclosures of the above application are incorporated herein by reference.

### FIELD OF THE INVENTION

The present invention relates to verification of tickets using electronic communication.

### BACKGROUND

Devices, such as smartphones, may store data relating to the bearer of the device. Such data could be transmitted between devices. However, specific application of ticket verification has not been previously addressed in the known prior art.

### SUMMARY

Embodiments of the present invention relate to method of electronic ticket verification, including positioning a host device, including a screen, a host input interface, and a wireless network adapter, at an access point to a venue at an event time, verifying, by tap verification, an electronic ticket, wherein tap verification includes establishing a wireless connection between the host device and a client device, receiving gesture input through the host input interface, receiving by the host device an attribute of a client electronic ticket from the client device over the wireless network adapter, and searching a ticket data for the received attribute.

Additional embodiments of the present invention relate to an electronic ticket verifier, including a host device positioned at an access point to a venue at an event time, the host device comprising a screen, a host input interface, and a wireless network adapter, wherein the host device is configured to wirelessly connect with a client device at the access point, wherein the host device is configured to receive a gesture input through the host input interface, wherein the host device is configured to receive an attribute corresponding to an electronic ticket issued to the client device after wireless connection and receipt of the gesture input, and wherein the host device is configured to select the attribute in a ticket data.

Further embodiments of the present invention include a method of requesting payment, including selecting an attendee device from an attendee data, the attendee device corresponding to a bearer of the attendee device that is at an event at a venue, and sending a payment request to the attendee device.

### BRIEF DESCRIPTION OF THE DRAWINGS

Various aspects of the present invention are illustrated by way of example, and not by way of limitation, in the accompanying drawings, wherein:

FIG. 1 depicts a diagram of a host device and a client device optionally connected to a server over an internet connection in accordance with the principles of the present invention;

FIG. 2 depicts a diagram of a tap verification network between the client device and the host device of FIG. 1 in accordance with the principles of the present invention;

FIG. 3 depicts a block-level diagram of a method of event management using tap verification in accordance with the principles of the present invention;

FIG. 4 depicts a block-level diagram of the tap verification method of the server of FIG. 1 in accordance with the principles of the present invention;

FIG. 5 depicts a block-level diagram of the tap verification method of the client device of FIG. 1 in accordance with the principles of the present invention; and

FIG. 6 depicts a block-level diagram of a controller in accordance with the principles of the present invention.

FIG. 7 depicts an electronic payment processing system in accordance with the principles of the present invention.

FIG. 8 depicts a method accepting payments in accordance with the principles of the present invention.

FIG. 9 depicts an automated access point to the venue in accordance with the principles of the present invention.

FIG. 10 depicts an alternative automated access point to the venue in accordance with the principles of the present invention.

FIG. 11 depicts a block-level diagram of a method of altering the state of a restriction mechanism of an automated access point in accordance with the principles of the present invention.

### DETAILED DESCRIPTION OF THE PREFERRED EMBODIMENTS

### Description

The structures and methods described herein may include authentication of users/guests at the door of an event, such as a house party, concert, etc. Embodiments of the invention may comprise a fully offline admission system capable of verifying to a host whether an attendee has purchased a valid ticket, wherein local electronic communication may be used to transfer one or more attributes of an electronic ticket and verify the electronic ticket. The invention may be embodied as software for validating users and general-purpose hardware, or as a specialty hardware circuit for validating users. The invention may comprise device to device communication, not necessarily to share general data, but to validate a user to an event or service. Embodiments of the invention may use low-range protocols such that calculation of device proximity may not necessarily be required.

The present invention may comprise a peer to peer solution. Such multi-peer connectivity may establish a connection between two devices, such as two smartphones. Example systems may combine Bluetooth Low Energy protocol and Wi-Fi protocol. Once connection is established, the attendee phone (e.g. client device) may broadcast its unique ticket identifier. The host device may receive the unique key and cross check the unique key across known valid tickets. The known valid tickets may be fetched whenever the host device is connected to the internet. The host device may have a valid internet connection to retrieve new tickets, but may not necessarily require an internet connection to validate tickets. The host device may store ticket data and/or attendee data locally. The attendee phone may store its tickets locally, and may not necessarily need internet connection beyond the initial purchase of the ticket. If a guest has a valid ticket on the client device, the host device screen may flash green, or another verification visual, signaling the host to allow entry. If the guest does not have a valid ticket the screen may flash red, or another negative verification visual, and the guest may be turned away or required to purchase a ticket.

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a controller, a general purpose computer, a special purpose computer, or other programmable data processing apparatus to produce a machine, such that the instructions, which executed via the processor of the controller or other programmable data processing apparatus, create means for implementing the functions/acts specified in the flowchart and/or block diagram block or blocks.

These computer program instructions may also be stored in a computer readable medium that can direct the controller, the computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto the controller, a computer, a smartphone, other programmable data processing apparatus, or other devices to cause a series of operational steps to be performed on the controller, other programmable apparatus or other devices to produce a controller implemented process such that the instructions which execute on the controller or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a method, system, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product on a computer-usable storage medium having computer-usable program code embodied in the medium.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Aspects of the invention were chosen and described in order to best explain the principles of the invention and the practical application, and to enable others of ordinary skill in the art to understand the invention for various embodiments with various modifications as are suited to the particular use contemplated.

With respect to the description herein, “tap” or “tap verification” refers to a local electronic connection between a host device and a client device within electronic communication range. For example, the electronic communication range may be near field communication range, Bluetooth range, Bluetooth low energy range, or the range of any other electronic communication protocol mentioned herein. For example, a tap may be initiated by near field connections between the devices, such as a connection at a distance of about 4 cm or less between the devices, in some embodiments. Additional embodiments include a tap initiated over Bluetooth or Bluetooth low energy at a range of 100 m or less. Other embodiments may not necessarily comprise a distance limit between the devices. Embodiments may include a response time limit between the devices. The tap may be initiated by physical contact between the devices, in some embodiments. The tap may be initiated by proximity to establish Near Field Communication connection between the devices. The tap may not necessarily require physically touching the devices, but may be initiated by input into one or both devices. The tap may be initiated by contact between devices, a simultaneous gesture, a non-simultaneous gesture on one or both devices. A gesture may include a button press, voice command, etc. on the client device, the host device, or both, in some embodiments. Additional embodiments include both proximity, such as both devices positioned at or within four centimeters, and a simultaneous gesture or non-simultaneous gesture. The tap may initiate the ticket verification process in some embodiments. In some embodiments, the tap may include a gesture initiated before or as connection is established between the host device and the client device. The gesture may be received through an input interface of the corresponding device.

With respect to the description herein, “local electronic connection” refers to a device-to-device connection over which signals conveying electronic data may be sent between the connected devices. Examples of a local electronic connection include near field communication, Bluetooth, low energy Bluetooth, other radio frequency connection, infrared, Wi-Fi, Ethernet, etc. In some embodiments the connection may be directly between the devices. However, embodiments such as Wi-Fi, may include an intermediate device, such as a router on a local area network.

With respect to the present application, “access point” refers to an entryway to a corresponding venue, including a doorway, a door, a stanchion, a bouncer, and/or a turnstile.

With respect to the present application, “about” or “approximately” means within plus or minus one at the last reported digit. For example, about 1.00 means 1.00±0.01 unit.

With respect to the present application, “around” used in conjunction with a numeral measurement means within plus or minus one unit. For example, around 50% means 49%-51%. For example, around 11.01 units means 10.01-12.01.

With respect to the present application “and” and “or” shall be construed as conjunctively or disjunctively, whichever provides the broadest disclosure in each instance of the use of “and” or “or.”

The ticket verification process may include a client device, a host device, and/or a server. The client device may be associated with a client user of a device (e.g. smartphone) having an application for managing electronic tickets corresponding to the event-goer or attendee client user. The host device may be associated with the event host that may manage the ticket data corresponding to the client user devices. The server may allow for transfer of ticket data to the host device for later verification between the client device and the host device. However, embodiments include generation of the electronic ticket by the host device and direct transfer of the ticket to the client device. In these embodiments, the host device may store the ticket data and/or attendee data locally for later ticket verification.

FIG. 1 depicts a diagram of a host device 102 and a client device 104 optionally connected to a server 106 over an internet connection 108 in accordance with the principles of the present invention. The host device 102 may comprise a host input interface 112, such as host screen 114 and/or host button 116. In some embodiments, the host input interface 112 may comprise touch capability of the host screen 114, keys, buttons, a mouse, or the like, independent of the screen. For example, the host screen 102 may display a graphical user interface that may display buttons or other widgets that encourage user access to operate functions, such as a tap. The client device 104 may comprise a client input interface 118, such as client screen 120 and/or client button 122. In some embodiments, the client input interface 118 may comprise touch capability of the client screen 120, keys, buttons, a mouse or the like, independent of the screen. For example, the client screen 104 may display a graphical user interface that may display buttons or other widgets that encourage user access to operate functions, such as a tap.

For example, host device 102 may be connected to server 106 by internet connection 108. Additionally, client device 104 may be connected to server 106 by internet connection 108. However, embodiments of the present invention do not require internet connections 108 and 110 at all times. Therefore, embodiments include instances wherein only one of internet connections 108 or 110 are connected at a particular moment. Furthermore, embodiments may include moments where neither of internet connections 108 and 110 are established. Therefore, the processes described herein are not necessarily required to occur synchronously, or even within a single session. The ticket purchase and verification process may occur over separate, independent sessions. In alternative embodiments, internet connections 108 and/or 110 may comprise local electronic connections.

Internet connection, such as internet connection 108 and/or internet connection 110, may be established via internet connection hardware such as a circuit configured as a wired or wireless internet or network adapter or other means of electronic communication. For example, the internet connection 108, 110 may comprise an Ethernet jack for wired connection directly or indirectly to a local router, modem, server, transmitter tower such as a radio tower, satellite and/or any other gateway to the worldwide web. In other embodiments, the internet connection 108, 110 may comprise a wireless card, circuit, or wireless network adapter. The wireless card may be wirelessly connection directly or indirectly to a local router, modem, server, transmitter tower such as a radio tower, satellite and/or any other gateway to the worldwide web. In some embodiments, the internet connection 108, 110 may be wirelessly connected directly to another computer or handheld device, such as a phone, watch, or tablet. In other embodiments, internet connection 108, 110 may engage in electronic communication with another computer or device by infrared (IR) transmitter and receiver, Bluetooth connection, fiber optic connection, cellular or mobile network (e.g. fixed area transceivers), or any other connector for transferring electronic data. For example, the internet connection 108, 110 may send data over Bluetooth connection to a computer, server, or other device. The server 106 may then upload and/or host the data for access via internet connection 108, 110. Additional embodiments include an internet connection 108, 110 that is configured to send the store data over Bluetooth, infrared communication, etc. directly to the server 106. Internet connection 108, 110 may transmit data via analog or digital signal, UDP or TCP, http, https, ssh, ftp, sftp, etc., or any other means to transfer electronic data.

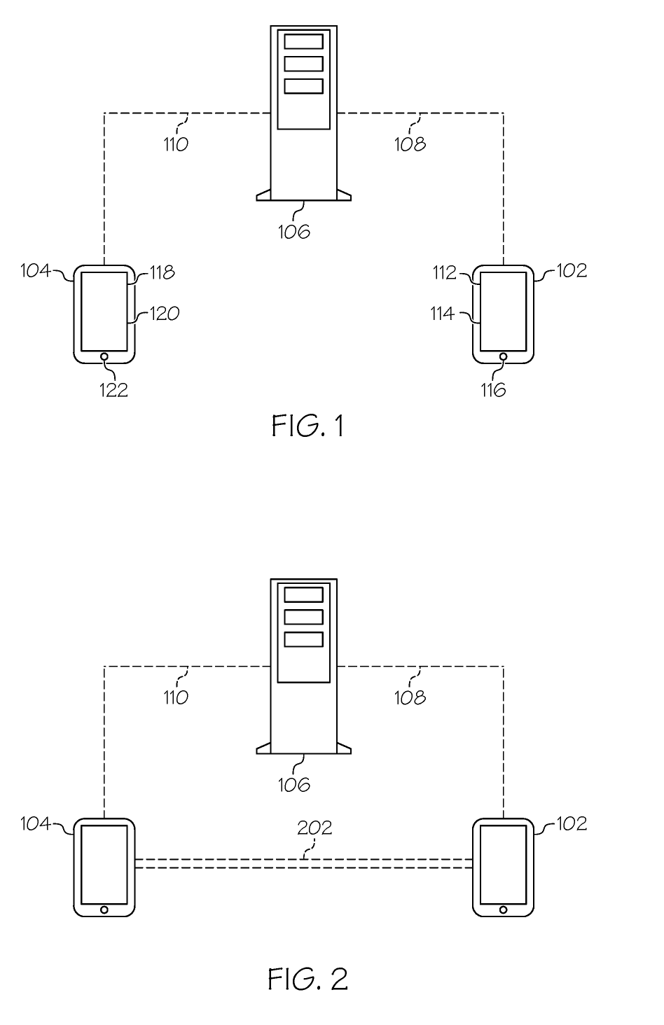

FIG. 2 depicts a diagram of a tap verification network between the client device 104 connected with the host device 102 of FIG. 1 over a local electronic connection 202 in accordance with the principles of the present invention. The host device 102 may be connected to the server 106 over an internet connection 108. The client device 104 may be connected to the server 106 over an internet connection 108. Local electronic connection 202 may comprise near field communication, as explained below. In some embodiments, local electronic connection 202 may comprise Bluetooth, Bluetooth low energy, infrared, or any other wireless connection. In embodiments utilizing NFC, the short-range nature of the connection may allow skipping collocation determinations between the host device 102 and the client device 104. However, in other embodiments, collocation may be used to verify the occurrence of a tap between the host device 102 and the client device 104.

In some embodiments, the communication protocols between the devices may be embodied in private Apple APIs, such as the Multipeer Connectivity Framework. For example, infrastructure Wi-Fi networks, peer-to-peer Wi-Fi, Bluetooth personal area networks, etc. may be used to connect the host device 102 and the client device 104. Furthermore, Multipeer Connectivity may automatically switch between protocols, as available and/or as needed, automatically in the background. Multipeer connectivity may comprise two phases, discovery phase and session phase. In the discovery phase, one or both of the host device 102 and the client device 104 may browse for nearby peer devices. One or both of the host device 102 and the client device 104 may advertise, meaning that the advertising device may signal its availability to a browsing device. The browsing device may then invite the advertising device to a session. In some embodiments, the advertising device may invite the browsing device to a session. The invited device may then accept or reject the invitation for the session. For example, if the app is in the foreground of the device, the device may be advertising and/or browsing. Additionally, if the app is pushed to the background, the device may cease advertising and/or browsing. When the host device 102 and the client device 104 connect, the devices may transition from discovery phase to session phase. The host device 102 and the client device 104 may perform the ticket verification data transactions described in the ticket verification process described herein in the session phase.

Bluetooth, Wi-Fi, and/or near field communication may be used for local electronic connection 202. All three may allow wireless communication and data exchange between digital devices, such as smartphones. Yet near field communication utilizes electromagnetic radio fields while technologies such as Bluetooth and Wi-Fi focus on radio transmissions.

Near field communication, or NFC for short, is an offshoot of radio-frequency identification (RFID) with the exception that NFC is designed for use by devices within close proximity to each other. There are several common forms of NFC standards: Type A, Type B, and FeliCa.

Devices using NFC may be active or passive. A passive device, such as an NFC tag, may contain information that other devices can read but may not necessarily read any information itself. Therefore, a passive device may be represented by the depiction of a sign on a wall. Others may read the information, but the sign itself may merely transmit the information to authorized devices.

Active devices may read information and may also send information. An active NFC device, such as a smartphone, would be able to collect information from NFC tags. Furthermore, the active device may be able to exchange information with other devices. Additionally, the active device may even alter the information on another NFC tag, if authorized to make such changes.

To ensure security, NFC may establish a secure channel and may use encryption when sending sensitive information such as credit card numbers. Therefore, embodiments of the present invention may include the encryption of data, such as user data, ticket data, etc., that may be sent to the server 106, host device 102, and/or client device 104.

Bluetooth and near field communication share several features, both being forms of wireless communication between devices over relatively short distances. NFC may be limited to a distance of approximately four centimeters while Bluetooth may reach over thirty feet. While it may seem that Bluetooth is superior in this regard, both Bluetooth and NFC technology have their advantages and disadvantages compared to one another and can work together to meet users' needs.

NFC technology may consume little power when compared to standard Bluetooth technology. Only when NFC has to power a passive, unpowered source such as an NFC tag may it require more power than a Bluetooth transmission. Furthermore, the low range of NFC communication may be useful as the NFC connection may be an indicator of a purposeful event trigger, such as a tap for ticket verification.

The close proximity of NFC may be useful in crowded locations such that interference from other devices may be avoided. Bluetooth may have trouble dealing with interference when trying to send signals between two devices, especially when several other devices are in close proximity Another benefit of NFC technology comes in its ease of use. Bluetooth may require users to manually set up connections between smartphones and takes several seconds. However, embodiments of the present invention include the host device 102 and the client device 104 comprising an electronic communication unique key (e.g. a unique application key, a unique event key, etc.) that is shared between the host device 102 and the client device 104. The host device 102 and the client device 104 may then match as electronic communication pairs (e.g. Bluetooth low energy pairs, WiFi pairs, etc.) Upon matching the electronic communication unique key, the ticket verification process may occur over the electronic communication connection established. NFC may connect automatically in a fraction of a second.

Bluetooth does still offer a longer signal range for connecting during data communication and transfers. NFC technology has taken advantage of this and can connect two devices quickly, then turn the signal over to Bluetooth so the owners can move further away without severing the connection. However, the latest development in Bluetooth technology, Bluetooth low energy (BLE), may be targeted at low power consumption and may use less power than NFC.

ISO/IEC 18000-3 is an international standard for devices communicating wirelessly at the 13.56 MHz frequency using Type A or Type B cards, such as in near field communication. In some NFC embodiments, the devices may be at or within 4 cm of each other in order to transmit information. The standards govern the process whereby a device and the NFC tag it is reading should communicate with one another. The device may be referred to as the interrogating device while the NFC tag may be referred to as the tag.

To function, the interrogator (e.g. the host device 102 or the client device 104) may send out a signal to the tag (e.g. the client device 104 or the host device 102, as the counterpart to the interrogator). This signal may include one or more of a protocol identifier, an application identifier, event identifier, and/or a device identifier. The protocol identifier may be used to determine the communication protocol to be used. The application identifier may be used to verify that the interrogator 102, 104 and the tag 104, 102 are using the same application (e.g. iPhone app), agnostic of the specific device. In these embodiments, the client device 104 may send only the ticket unique key. If the ticket unique key is in the list of unique keys stored by the host device 102, then the ticket may be verified.

However, embodiments include the client device 104 sending a device identifier that the host device 102 may verify before continuing through the ticket verification transaction. In further embodiments, the ticket may include an event identifier that may be transferred to the client device 104. The client device 104 may use the event identifier to communicate with the host device 102 that the client device 104 is associated with the event before continuing through with ticket verification.

The two devices create a high frequency magnetic field between the loosely coupled coils in both the interrogating device 102, 104 and the NFC tag device 104, 102. Once this field is established, a connection 202 may be formed and information can be passed between the interrogator 102, 104 and the tag 104, 102. The interrogator 102, 104 may send the first message to the tag 104, 102 to find out what type of communication the tag 104, 102 uses, such as Type A or Type B. When the tag 104, 102 responds, the interrogator 102, 104 may send its first commands in the appropriate specification.

The tag 104, 102 may receive the instruction and may check if it is valid. If the instruction is a valid request, the tag 104, 102 may then respond with the requested information. For sensitive transactions such as credit card payments, ticket verifications, etc., a secure communication channel may first be established and all information sent may be encrypted (e.g. ticket data).

NFC tags may function at half duplex while the interrogator may function at full duplex. Half duplex refers to a device that can only send or receive, but not both at once. Full duplex may send and receive simultaneously. By way of example, commands may be transmitted from the interrogator 102, 104 using PJM (phase jitter modulation) to modify the surrounding field and send out a signal. The tag 104, 102 may answer using inductive coupling by sending a charge through its coils.

In addition to the signaling technologies used by near field communication technology, four tag types and two sets of active/passive roles exist. Tag types may refer to the speed and compatibility between an NFC tag and NFC readers, and the roles define how active and passive devices respond during a NFC communication. Often, a URL may be embedded in a NFC tag. URLs take up only a small amount of memory, lowering the production cost of the NFC tags since many may be placed on posters or other items that are thrown away later on. NFC tags can, however, hold nearly any type of information, though more memory may increase cost.

Type 1: Type 1 NFC tags have data collision protection and can be set to either “read and rewrite capable” or “read-only.” Read-only programming may prevent the information from being changed or written over once embedded in the tag. Type 1 tags may have 96 bytes of memory, enough for a URL or a small amount of data. The tag's memory can expand to a larger size as needed.

Type 2: Type 2 NFC tags may also have data collision protection and can be rewriteable or read-only. They start at 48 bytes of memory, half of what the type 1 tags can hold, but can expand to be as large as a type 1 tag. Communication speeds are the same for tag types 1 and 2.

Type 3: Also equipped with data collision protection, NFC tag type 3 may have larger memory and faster speeds than tag types 1 and 2. Such tags may be part of the FeliCa system. The bigger size lets it hold more complex codes beyond URLs, at an increased cost.

Type 4: Type 4 NFC tags can use either NFC-A or NFC-B communication and may have data collision protection. The tag is set as either rewritable or read-only when manufactured and this setting may not necessarily be changed by the user, unlike the other NFC tags which may be alterable at a later date. The tag holds 32 Kbytes in memory and has faster speeds than the other tags.

In addition to the four tag types, four modes of operation exist. The modes—reader/writer, card, initiator, and target—describe what role a device or tag is playing in an NFC transaction. Devices may switch between more than one role depending on the transaction being processed.

Reader/Writer and Card—A transaction may occur between an active device that sends out signals and receives information and a passive device that simply sends the information and does not receive anything other than instructions on what data to reply with. The reader/writer may be a smartphone serving as the active device and the card may be an NFC tag serving as the passive device. Smartphones can take on the role of card, however, such as when they act as a credit card for contactless payments. Then the credit card reader may become the reader/writer and the smartphone may serve as the passive card device.

Initiator and Target—NFC technology may have a major advantage over other technologies such as RFID. NFC may create peer-to-peer sharing between devices, such as two phones. In this case, the device (e.g. host device 102 or client device 104) making the connection or sending an invitation may be the initiator and the counterpart device (e.g. client device 104 or host device 102) receiving the instructions and sending back information may be the target. Both device may serve either role in that the devices may both query the counterpart device and then receive information from the counterpart device.

In some embodiments, collocation may be established when a near field communication connection is established. However, the limited range of the communication protocol may not necessarily be the limiting factor that establishes collocation for wireless communication at a range of two feet or greater. Thus, embodiments include establishing collocation (e.g. close proximity) of the devices prior to tap verification of an electronic ticket. In some cases, the devices may be considered collocated if they are both connected to the same Wi-Fi node, local area network, etc. In other cases, the devices may be considered collocated if they receive a common radio or electromagnetic signal with similar received signal strengths or with received signal strength greater than a threshold value. Further embodiments include that the devices may be considered collocated if they may be triangulated to be within a predetermined radius based on the location of both devices relative to satellites, cellular network transceivers, Wi-Fi nodes, such as by GPS or use of signal strengths. For example, some current methods of determining collocation between devices is disclosed in U.S. patent application publication number US 2011/0191823, the disclosures and contents of which are hereby incorporated in their entirety. Additionally, the devices may be considered collocated if a near field communication, Bluetooth, or Bluetooth low energy connection can be established between the devices.

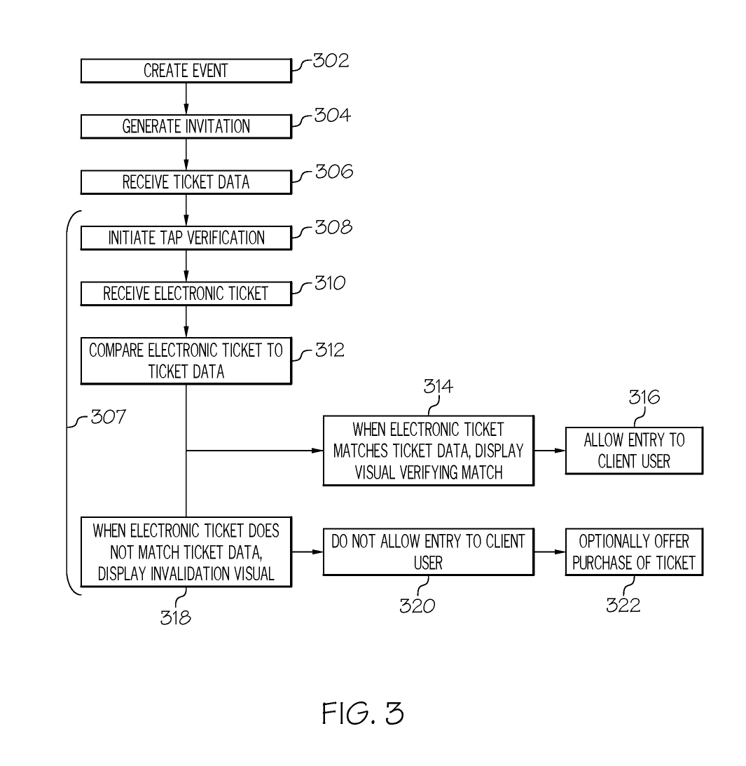

FIG. 3 depicts a block-level diagram of a method of event management using tap verification in accordance with the principles of the present invention. The steps of the method of FIG. 3 may be performed by the host device 102 and/or the server 106 At step 302, the host may create an event using the host device 102 in connection with the server 106. By way of example, the server 106 may host backend and/or frontend website, web application, etc. that may be reachable over internet connection 108, 110. In this manner, the server 106 may present options to the host device 102. The host device 102 may be used to select one or more options and provide data corresponding to the actions taken. Thereby, the host device 102 may administer an event on the server 106 by back-and-forth data communications over internet connection 108.

More specifically, the host device 102 may receive an option to create an event from the server 106. The host device 102 may send a request to create the event to the server 106. The server 106 may allocate storage, such as disk space, databases, etc. corresponding to the new event. Furthermore, the server 106 may restrict administrative access to the event to the host device 102 based on password protection, key pair protection, etc.

After the event is created, the host device 102 may set the attributes of the event, such as the title, the date, the time, the location, a description, etc. In some embodiments, the host device 102 may create a guest list with contact information that may allow reaching a corresponding client device 104 such as corresponding phone numbers, email addresses, etc. In these embodiments, step 304 may include generating invitations according to the guest list. For example, the host device 102 may send such a request to the server 106 and then the server 106 may send the invitations to the corresponding client device 104 by email, text, or other electronic communication allowing the electronic ticket to be stored in the client device 104. Alternatively, the host device 102 may directly send the invitations to the corresponding client devices 104. For example, the host device 102 may text an invitation link to the client device 104. The invitation link may redirect the client device 104 to an information page on the server 106 that may show one or more attributes of the event. The client device 104 may use the invitation link or a link on the information page to download an electronic ticket for later retrieval.

In other embodiments, the host device 102 may not necessarily provide a guest list to the server 106. Alternatively, the host device 102 may provide a guest list, wherein additional tickets may be available. Thus, the server 106 may be configured to include a ticket purchasing option on the event information page. Advertising and/or direct communications may be used to direct potential client devices 104 to the event information page. When a purchase and/or event confirmation is made, the electronic ticket may be downloaded.

The electronic ticket may comprise a ticket identifier, such as an id number. For some embodiments the electronic ticket may further comprise a code, such as a generated hash, corresponding to the ticket identifier. A ticket data may correspond to one or more electronic tickets. The electronic ticket may comprise a ticket identifier, an event identifier, a device identifier, and/or the corresponding code (referred to as “attributes”). The electronic ticket may be downloaded by the client device 104. The ticket data may be downloaded by the host device 102.

In step 306, the host device 102 may receive one or more electronic tickets, when connected to the server 106. Each electronic ticket of the ticket data stored on the host device 102 and/or the server 106 may correspond to an electronic ticket provided to each corresponding client device 104. The host device 102 may store the ticket data for offline use. For example, the host device 102 may store the ticket identifier and the code in a table, database, string, structure data file etc. One or more of the ticket identifier, code, event identifier, and/or device identifier may be searchable by the host device 102 and/or the server 106, such as by database select query, regular expression, or any other search method appropriate for the corresponding electronic storage. For example, successful selection of an attribute may refer to a select query in which data is returned rather than a False or Null object or variable. The search may return a match and/or a Boolean corresponding to the search result. By way of example, a hash stored for the code may not necessarily be unique and therefore the ticket identifier, event identifier, and/or device identifier may also be searched for ticket verification.

The tap verification process 307 may be referred to as “tap verification” herein.

When the event occurs, the host device 102 may be positioned at an access point of the event venue before and/or during the event, e.g. the host device 102 may be located at the event location and time. In this manner, the host device 102 may be used to verify and/or invalidate electronic tickets on client devices 104, non-client devices, and potential client devices. For example, in step 308, the host device 102 may initiate and/or receive a tap with a client device 104. In alternative embodiments, the client device 104 may initiate and/or receive a tap with the host device 102. The corresponding device may receive gesture input from the corresponding user (e.g. host or client) through the corresponding input interface. The corresponding device may compare the received gesture input to a data model representing a gesture. When the received gesture input sufficiently corresponds to the gesture data model, the corresponding device may determine that a gesture has been received. By way of example, the host device 102 or the client device 104 may receive a gesture through the corresponding input interface while connected by NFC (e.g. within 4 cm of the corresponding device) to initiate tap transfer. In some embodiments, both the host device 102 and the client device 104 may receive simultaneous gestures while connected by NFC (e.g. within 4 cm of the corresponding device) to initiate tap transfer.

Upon initiation of a connection between the host device 102 and the client device 104, the connection may be validated, such as by device identifier, event identifier, etc. The client device 104 and the host device 102 may then establish a data connection over which the ticket may be validated. This data connection between the host device 102 and client device 104 may be a direct wireless connection without intervening devices, such as an NFC connection. The client device 104 may send its electronic ticket, or a corresponding electronic ticket attribute, corresponding to the event to the host device 102. The host device 102 may receive the electronic ticket, and/or an electronic ticket attribute, in step 310. The host device 102 may use the ticket identifier to retrieve the corresponding stored unique key from a ticket or a ticket data (e.g. a stored database corresponding to the information of each authorized ticket). The host device 102 may then compare the electronic ticket unique key to the stored unique key in step 312. In embodiments, other unique attributes may be compared. If the unique keys match, such as in step 314, the host device 102 may display a visual indicating the match, such as on the host screen 114 through the GUI.

Alternatively, the host device 102 may receive the unique key from the client device 104, and then may simply check the unique key for inclusion in its list of unique keys for the event. In the event of a visual indicating verification of the ticket, the host may grant access to the bearer of the client device 104 (e.g. a corresponding client user) in step 316.

“Client user” may refer to the bearer of the client device 104 and/or a group of people corresponding to one or more tickets stored on the client device 104. Granting access may mean that the host physically allows the client user to pass into the event venue. Further embodiments include automated means, such as automatic unlocking of a door, turnstile, etc. to the venue.

However, when a client device 104, non-client device, or potential client device does not produce an electronic ticket having a valid unique key, the host device 102 may display a visual indicating the absence of a valid ticket in step 318. In some embodiments, the host may then deny entry to the bearer of the client device 104, non-client device, or potential client device at step 320. In some embodiments, the host may have additional tickets available. In step 322, the host may allow purchase of tickets. This may occur by conventional paper methods, conventional electronic methods, and/or the methods described herein.

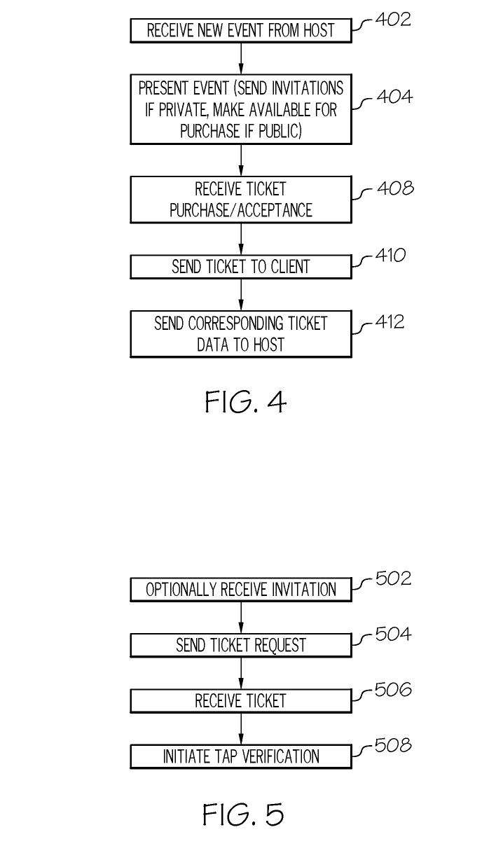

FIG. 4 depicts a block-level diagram of the tap verification method of the server 106 of FIG. 1 in accordance with the principles of the present invention. The server 106 may comprise hardware and/or software sufficient for operating an internet server. For example, the server 106 may comprise a Linux, Apache, MySQL, PHP (LAMP) stack, or any other software combination capable of receiving, processing, and sending data requests using internet protocol.

In step 402, the server 106 may receive a new event request from the host device 102. The server 106 may allocate storage space, databases, tables, or other resources to the created event. Furthermore, the server 106 may present this event on a webpage or through an application. The server 106 may require user authentication for administration of the event, whereby event information may be provided or changed. Furthermore, client access to the event page may be restricted (e.g. by password, key, etc.), obfuscated (e.g. by unrecognizable URLs), or openly presented. In step 404, the server 106 may present the event, such as by serving the webpage, sending emails with a link, sending texts, and/or otherwise making the event information and ticket purchase options publicly available.

In some embodiments, the server 106 may receive a ticket purchase or acceptance notification in step 408. The server 106 may generate an electronic ticket (a “ticket” herein) comprising one or more of a ticket identifier, a device identifier (e.g. a host device identifier or a client device identifier, upon download of the ticket by the client device 104), an event identifier, and a unique key. The server 106 may store the ticket and corresponding information, e.g. by database indexed by ticket identifier. The ticket may be served or sent to the client device by the server 106 for download by the client device 104 after purchase or acceptance of the ticket in step 410. Furthermore, the electronic ticket may be sent by the server 106 to the host device 102, in step 412, after the purchase or acceptance of the ticket, upon purchase or acceptance, upon download of the electronic ticket by the client device 104, etc. The host device 102 may then store the electronic ticket in the ticket data in memory, by disk storage, or other non-transitory electronic storage.

FIG. 5 depicts a block-level diagram of the tap verification method of the client device 104 of FIG. 1 in accordance with the principles of the present invention. The client device 104 may optionally receive an invitation regarding the event in step 502. In the event of acceptance of the invitation or purchase of a ticket, the client device 504 may send a ticket request to the server 106 and/or the host device 102, in step 504. The server 106 may then generate a ticket. In some embodiments, the ticket may be associated with the client device 104, such as associated by user identifier. The server 106 and/or the host device 102 may then send the ticket directly to the client device 104 or serve the ticket download from the webpage or app. In step 506, the client device 104 may receive and/or store the ticket in memory and/or storage.

At the event venue (e.g. time and location), the bearer of the client device 104 may present the client device 104 for entry. For example, a tap between the client device 104 and the host device 102 may be initiated, in step 508. Step 508 may be similar in all respects to step 308. In some embodiments, the client device 104 may initiate the tap. However, embodiments include initiation of the tap by the host device 102. Upon initiation of the tap or before, a connection between the client device 104 and the host device 102 may be established. In embodiments wherein the connection is established by near field communication, the connection may be established upon proximity of the device and data transfer initiated upon a tap gesture. The client device 104 may send the ticket and/or sufficient attributes to verify the ticket. For example, the client device 104 may send the ticket identifier and the code to the host device 102. The host device 102 may validate the ticket unique code against the stored code corresponding to the ticket identifier. Upon verification, the host device 102 may display a corresponding visual indicator. Subsequently, the host may allow the client device bearer access to the event. If the visual indicator does not indicate a valid unique code, the client device bearer may be prevented access from the event venue.

In some embodiments, allowing or preventing access may be performed by human means, such as by the host, employees, bouncers, etc. In other embodiments, the host device may be connected with a turnstile or door. Upon verification, the turnstile or door may become unlocked to allow passage of the client device bearer.

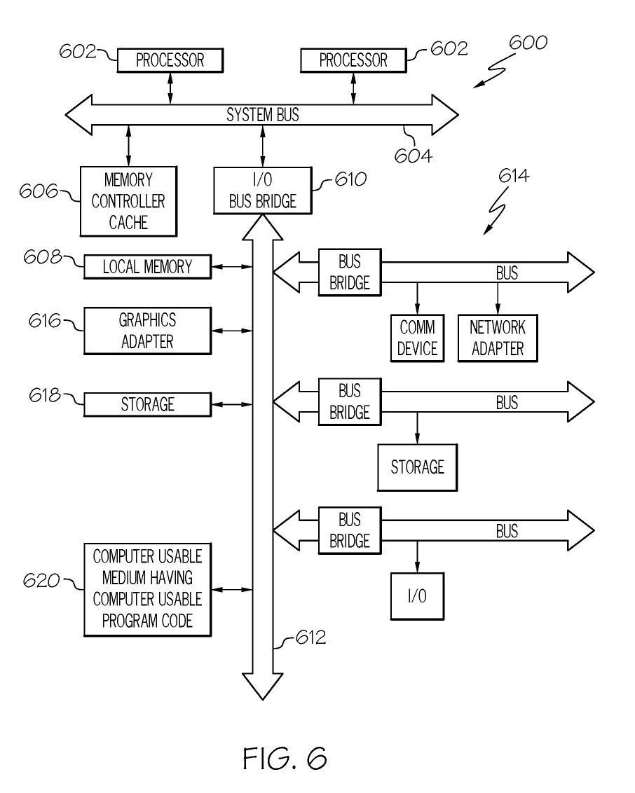

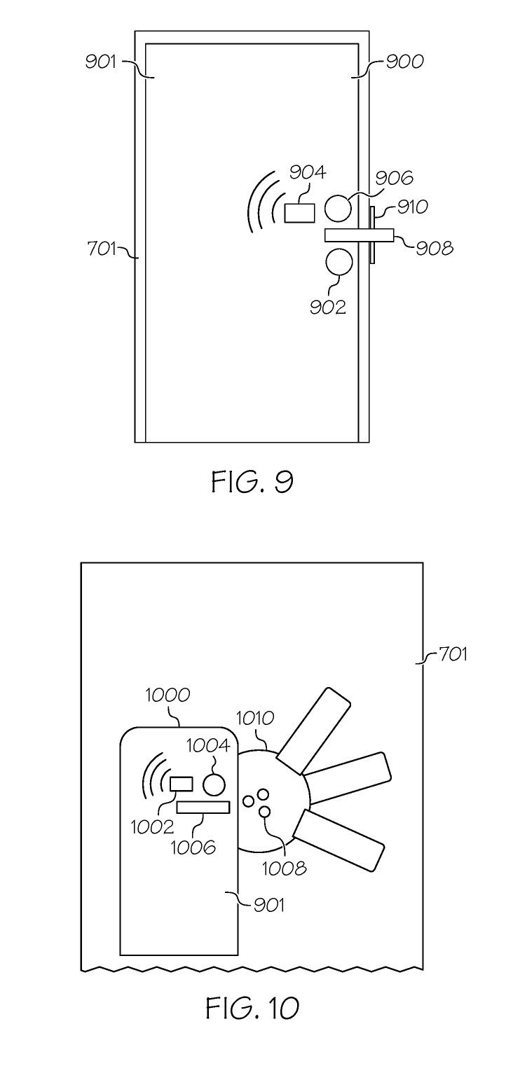

FIG. 6 represents a block-level diagram of a controller 600 in accordance with the principles of the present invention. Similar controllers may be found in the host device 102, the client device 104, the server 106, automated access points (described with respect to FIGS. 9-11), etc. that may be programmable to carry out the ticket verification processes described in accordance with the principles of the present invention. The controller 600 may be any device capable of sending and receiving electronic data over an interface. For example, a microcontroller or a computer could be used. The controller 600 may also perform operations on and/or modify the data it receives.

The controller 600 may be embodied as hardware circuits or may be software embodiments wherein program code, such as java, C++, etc, manipulates the hardware of a general purpose hardware circuit. Software embodiments may be implemented as low-level code or even as high-level code operating within an operating system, such as Unix, BSD, Microsoft Windows, iOS, etc.

Controller 600 may comprise a processing unit (CPU) 602, local memory 608, peripherals and interfaces, and a general-purpose input/output (I/O) interface. In some embodiments, the controller 600 may comprise more than one processor 602. The processor 602 may be in electrical communication with a system bus 604. The controller 600 may further comprise local storage, such as memory controller/cache 606, local memory 608, storage 618 etc. The memory controller/cache 606 and/or I/O Bus Bridge 610 may be in electrical communication with system bus 604. Memory controller/cache cache 606 may provide an interface to local memory 608, in some embodiments. I/O bus bridge 610 may be in electrical communication with I/O Bridge 612. The I/O Bridge 612 may interface with local memory 608, the graphics adapter 616, storage 618, computer usable medium having computer usable program code 620 (e.g. such as may be embodied on storage 618). By way of example, one or more bus bridges may provide an interface between I/O bridge 612 and bus interface 614. Bus interface 614 may provide an interface with one or more of a communications device, network adapter, storage, or input/output devices, such as a mouse, keyboard, touch screen, screen, printer, and/or other interface devices. The busses describe herein may comprise one or more of a control, address, and/or data bus for interfacing with the other components of the controller 600. In some embodiments, storage 618 may comprise any online, near-line, and/or offline storage, such as magnetic hard disk, solid state drive, etc.

Local storage may be used to store variables, constants, etc. for complex calculations. Local memory may interface with the CPU (processor 602) via a memory interface. The memory interface may allow the CPU to store calculated values, variables, constants, or any other important electronic signal onto the physical local memory. The memory interface may include one or more direct memory access controllers. Of course, part or all of the local memory 608 may be committed to program storage, in which data relevant to the operation of the program is stored. Program storage may also be organized into useful data structures such as a stack or heap. The peripherals and interface and the general purpose I/O interface may interface to external input or output devices. Examples of external input or output devices include any electronic device capable of sending or receiving an electronic signal such as keyboards, mice, printers, scanners, digital sensor, analog sensors, Ethernet, analog to digital converters, ADC, UART, USB etc. Program storage, local memory, peripherals and interface, and general purpose I/O interface may be contained on the circuit board of the CPU. The controller 600 may further comprise a screen whereby the graphics adapter 616 may alter the display, such as at validation or denial of a ticket. In other embodiments, any of these parts may be external to the CPU and/or controller 600.

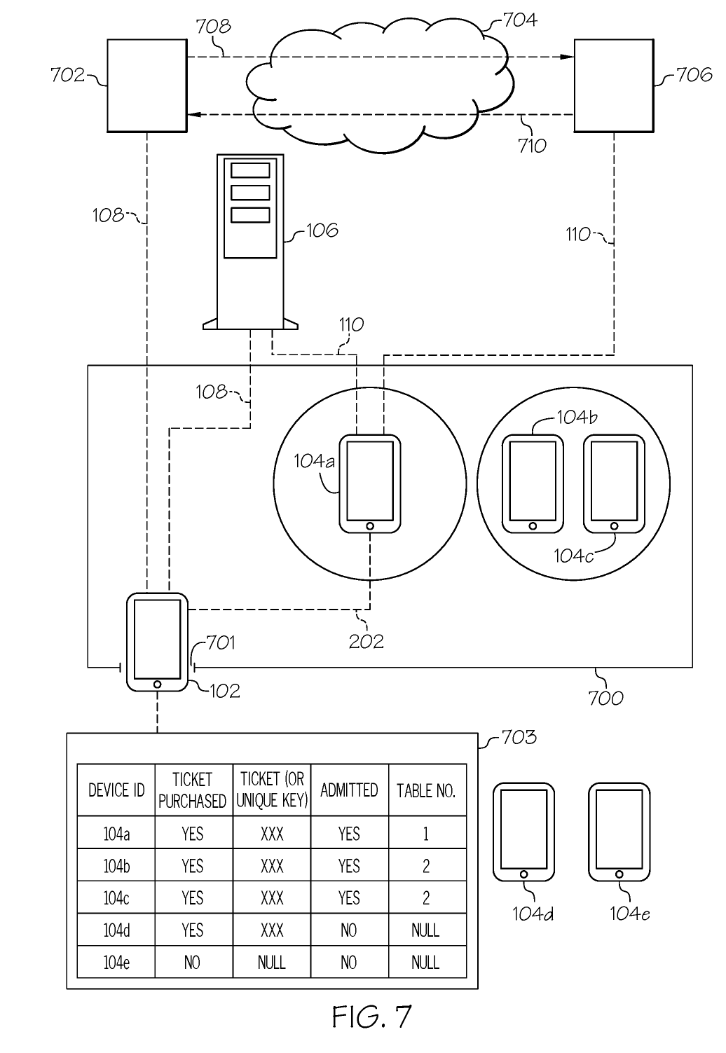

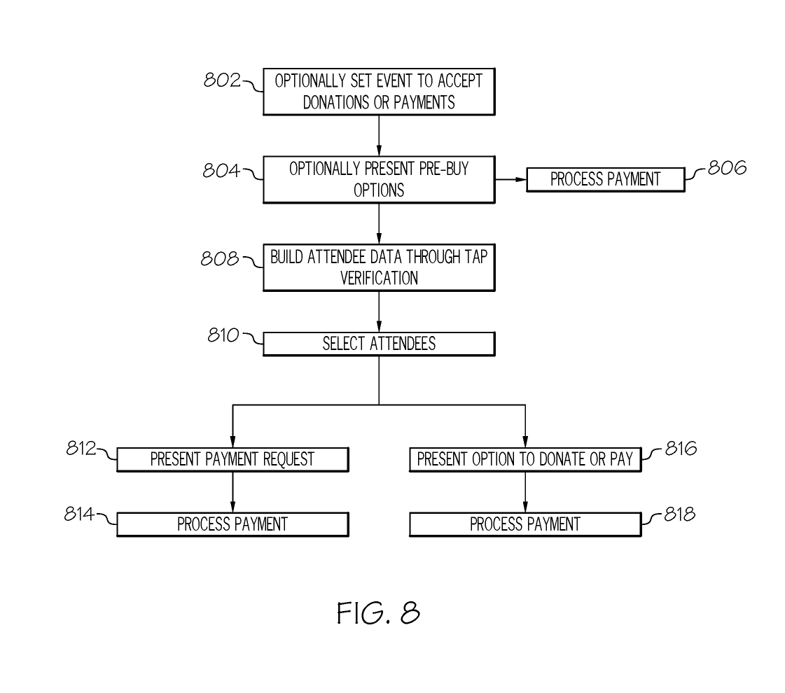

FIG. 7 depicts an electronic payment processing system in accordance with the principles of the present invention. As used herein, “payment processing” may be used to refer to the electronic payment processing as described with respect to FIG. 7.

Generally, the payment processing system may comprise an originator 702 in electronic communication with a receiver 706 over payment network 704. For example, the originator 702 may send an origination request 708 to the receiver 706. Furthermore, the receiver 708 may send a processing response 710, such as an authorization or denial of payment verification. The originator 702 and the receiver 706 may be financial institutions, and in some embodiments, may be the same financial institution. The host device 102 may correspond to a depository account with the originator 702. Thus, the host device 102 may be in electronic communication with the originator 702. The client device 104 may correspond to a depository account and/or a credit line with the receiver 704. Therefore, the client device 104 may be in electronic communication with a receiver 706. The host device 102 may send the necessary information to open a depository account with the originator 702. The client device 104 may send a purchase request and/or payment authorization to any of the host device 102, the server 106, and/or the receiver 706. The purchase request or payment authorization may comprise a partial purchase request or a partial payment authorization corresponding to partial payment apportioned to the bearer of the attendee device among multiple corresponding bearers of attendee devices. In these embodiments, the corresponding partial purchase request or partial payment authorization may be accepted by the host device 102 and/or the server 106. Furthermore, the recipient of the partial payment request or partial payment authorization may require all corresponding partial payments to account for the entire amount requested in the payment request before accepting one or more of the corresponding partial purchase requests or partial payment authorizations. For example, the partial purchase requests may correspond to multiple attendees splitting the bill for a pre-purchased table. Additionally, the partial payment authorization may correspond to multiple attendees splitting a cost accrued at the event, such as bottle service ordered.

In embodiments comprising electronic checks, depository account, or other automated clearinghouse payments, the originator 702 may comprise an originating depository financial institution (ODFI). In these embodiments, the payment processing system 704 may comprise an automated clearinghouse (ACH) system. Furthermore, the receiver 706 may comprise a receiving depository financial institution (RDFI). The host device 102 may receive a purchase request or payment authorization, such as from one or more of the client devices 104a-104c. The purchase request or payment authorization may comprise payment information, such as a bank account number and/or routing number, if not already stored by the host device 102, server 106, and/or originator 702. The host device 102 may send a corresponding payment processing request to the originator 702. The originator 702 may send a corresponding transfer request over the payment network 704 to the receiver 706. The receiver may debit the account corresponding to the client device 104 and may send payment confirmation to the originator 702. The originator may credit the account corresponding to the host device 102.

In some embodiments, the client device 104 may correspond to a credit card or other line of credit. In these embodiments, the originator 702 may be an acquiring financial institution, the payment network 704 may be a credit payment network, and the receiver 706 may be an issuing financial institution. Payments may be processed similar to the ACH processing explained above after a request from the host device 102 to the originator 702, except that the receiver 706 extends credit on the account corresponding to the client device 104 rather than debiting a depository account. In these embodiments, the payment processing request may comprise payment information, such as a credit card number, billing address information, and/or a CCV number.

FIG. 7 also depicts the positioning of the host device 102 at an access point 701 of a venue 700. Bearers of admitted client devices 104a-104c may be allowed entry into the venue 700 after tap verification of the corresponding electronic ticket, as explained above. As depicted, host device 102 and/or server 106 may store an attendee data 703. The attendee data 703 may comprise client device identifiers, corresponding tickets, corresponding ticket data, such as unique keys, ticket purchase flags, admission flags, table numbers, and/or custom grouping numbers. Furthermore, unadmitted client devices 104d and 104e may be identified in the attendee data 703. In this manner, host device 102 and/or server 106 may distinguish between admitted and unadmitted devices. In some embodiments, “ticket data” may be substantially similar to attendee data. Ticket data may comprise one or more electronic tickets. An electronic ticket may comprise a device identifier, a unique key, etc.

Before the admission process, the host may set up the event to include pre-buying options. For example, VIP access, table reservations, table service, etc. may be purchased before the client device 104 is presented for entry. The client device 104 may present these pre-buying options to the bearer of the client device 104. When a pre-buying option is selected, the client device 104 may send a purchase request to the host device 102 and/or the server 106. For example, pre-buying options may be presented to individuals or groups. When groups are selected, payment may be divided among the individuals of the group. Therefore, the purchase request and/or purchase authorization may comprise information corresponding to the bearers of the client devices 104. The total cost may be divided and the corresponding partial payment authorizations comprising amounts and individual payment details may be sent to the originator 702 as corresponding payment processing requests. The originator 702 may then send the appropriate transfer requests to the corresponding receivers 706. The receiver 706 may return corresponding payment confirmations. The electronic payment may then proceed accordingly.

In some embodiments, payment options may not necessarily be presented, except after admission following tap verification. For example, donation requests may be presented to attendees through corresponding admitted client devices 104a-104c and may exclude unadmitted client devices 104d and 104e. However, embodiments include requesting donations through all client devices 104a-104e. Upon receipt of the payment request from the client devices 104a-104e, the host device 102 and/or the server 106 may send the payment request to the originator 702 and payment processing may proceed.

In some instances, additional fees may be assessed. For example, property may become broken, etc. In these embodiments, the admitted client devices 104a-104c may be assessed a fee through the host device 102 and/or the server 106. In some embodiments, the client device 104 may be required to have a corresponding receiver 706 and payment method for entry into the venue 700. If an individual or group can be identified as responsible for the additional fees, the corresponding client device 104 may be assessed for payment processing.

FIG. 8 depicts a method accepting payments in accordance with the principles of the present invention. In optional step 802, the host may set the event to accept donations or payments. This setting may be stored, such as by a payment accepted flag, on the host device 102 and/or on the server 106. The payment accepted flag may be transferred to the client device 104 upon receipt of the invitation and/or after purchase of the ticket. The client device 104 may display payment options, such as for individuals, all ticketholders, all attendees, tables, or other groupings for cost sharing arrangements.

By way of example, setting the event to accept donations or payments in step 802 may further comprise setting up a host bank account with an originator 702 that corresponds to the host device 102. Furthermore, the client device 104 may be associated with a payment method, such as electronic check, ACH, credit card, credit line, or other electronic transfer in which the host device 102 and client device 104 may facilitate transactions between the host and one or more attendees through an electronic payment system. In some embodiments, attendees may be presented the option to join a cost sharing group, such as a table. In this example, the table may purchase bottle service. The tab may be split evenly among the table, with each client device 104 facilitating payment of the corresponding share of the split bill by sending payment information to the host device 102 for electronic payment processing. In some embodiments, the client device 104 may be required to be associated with payment information before allowing entry to the bearer of the client device 104 (e.g. the host device 102 may not necessarily show the positive visual indicator and/or the automated access point may not necessarily disengage the access restriction mechanism) such that fees can be assessed, such as in the event of property damage.

Returning to FIG. 8, step 804 may comprise optionally presenting pre-buying options, such as through an app (e.g. iphone application) or other online portal. These options may be presented after purchase of a ticket and before admission to the venue. Pre-buying options may include purchase of a table, VIP access, bottle service, etc.

The client device 104 may receive a click or other purchase confirmation from the user. The client device 104 may send the purchase confirmation, including payment amount and/or payment details to the host device 102 or the server 106. The host device 102 or the server 106 may then send the payment confirmation to the originator 702 in step 806 for payment processing.

In step 808, the attendee data 703 may be built through the tap verification process among client devices 104a-104e. Tap verification of step 808 may be substantially similar to tap verification 307. For example, the event may be starting at the venue 700. As client devices 104 verify tickets for entry via tap verification, the attendee data 703 may be altered correspond to verification and entry of the admitted client devices 104a-104c, negative verification (e.g. no authentic electronic ticket, the unique key doesn't match, etc.), and/or non-attendance of unadmitted client device 104d-102e.

In some embodiments, step 810 may comprise selecting attendees according to attendee data 703. For example, admitted client devices 104a-104c may be selected for a push notification, alert, passive presentation of payment options, etc. In some instances, the host device 102 or server 106 may comprise event data including the option to donate or pay additional amounts, such as for purchases or tips during the event at the venue 700. For example, such a donation could be for a social cause, political cause, and/or a non-profit organization. The donation or payment option may be presented on the admitted client devices 104a-104c, in step 816. The donation may be confirmed on the admitted client devices 104a-104c, as desired by the corresponding attendee (e.g. bearers of the corresponding client device 104) for payment processing. In alternative embodiments, the donation may be assessed to all attendees corresponding by admitted devices 102a-102c, with prior notice that attendance incurs a minimum donation. Upon receipt of the donation authorization or payment authorization by the host device 102 and/or the server 106, the payment processing request may be sent to the originator 702 for payment processing in step 818. In some embodiments, a group may be selected, such as by voluntary group creating amount admitted client devices 104a-104c, by table, or by other grouping. The grouped admitted client devices 104b-104c may be pushed a bill notification divided among the group. The grouped client devices 104b-104c may return payment authorizations to the host device 102 and/or the server 106. The host device 102 and/or the server 106 may then send the payment processing requests to the originator 702 for payment processing.

In some embodiments, optional step 812 may include presenting a payment request, such as to an individual admitted client device 104a-102c, a table or other subgroup of client devices 104b-104c, and/or all admitted client devices 104a-104c. Examples for assessing payments could include property damage, such as broken tables, etc. The appropriate payment authorizations may be sent from the corresponding admitted client devices 104a-104c to the host device 102 and/or the server 106. In some embodiments, payment information may be pre-collected by the host device 102 and/or the server 106, and may be a requirement, along with the tap verification, for entry. In step 814, the originator 702 may receive the payment processing requests and may begin payment processing accordingly.

FIG. 9 depicts an automated access point 901 to the venue 700 in accordance with the principles of the present invention. The venue 700 may include an access point 701, such as a doorway, in which access is physically restricted by a bouncer and/or a stanchion until tap verification. However, some embodiments include an automated access point 901. The automated access point 901 may comprise an automated door 900 and/or a turnstile (described with respect to FIG. 10).

The automated door 900 may comprise a controller 904 that is similar in all respects to controller 600. For example, the controller 904 may comprise a network adapter, such as a wireless network adapter. In this manner, the host device 102 may be in electronic communication with the controller 904, such as wireless electronic communication. Automated door 900 may comprise a doorknob 902.

The controller 904 may be in electrical communication with an access restriction mechanism. For example, the access restriction mechanism may comprise an electric motor 906 comprising a threaded axle that drives engagement and/or disengagement of a tenon 908 and mortise 910. When the tenon 908 and mortise 910 are engaged, the access point 901 may be inaccessible (e.g. the door may be prevented from opening and/or the turnstile may be prevented from rotating). When the tenon 908 and mortise 910 are disengaged, the access point 901 may be accessible (e.g. the door may be opened and/or the turnstile may be rotated). The access point 901 may be positioned at an entryway 701 of a venue 700.

Returning to FIG. 9, a thread of the electric motor axle may engage with a thread of a tenon 908 by rotary communication, in which rotation of the electric motor 906 may drive rotation of the tenon thread. Rotation of the electric motor 906 in a first direction may, through engagement of the threads, increase the length of the tenon 908 beyond the perimeter of the automated door 900. In this manner, the tenon 908 may be extended into a mortise 910, such as may be found in a door frame surrounding the door 900. This process may be described as engagement of the restriction mechanism.

Rotation of the electric motor 906 in a second direction may, through engagement of the threads, decrease the length of the tenon 908 beyond the perimeter of the automated door 900. In this manner, the tenon 908 may be withdrawn from the mortise 910, and the door 900 may be opened. This process may be described as disengagement of the restriction mechanism.

The controller 904 may be in electrical communication with an electric motor 906. After tap verification, the host device 102 may send a verification data to the controller 904. After receipt of the verification data, the controller 904 may trigger power to the electric motor 906 rotate the electric motor 906 in the second direction for disengagement of the restriction mechanism. In this manner, the bearer of the client device 104 may be allowed entry into the venue 700. After entry, such as upon the door closing, the controller 904 may trigger power to the electric motor 906 to cause rotation in the first direction for engagement of the restriction mechanism. In some embodiments, negative verification of a client ticket by the host device 102 may include the host device 102 sending a negative verification data to the automated door 900. The controller 904 may trigger engagement of the restriction mechanism after receipt of the negative verification data.

FIG. 10 depicts an alternative automated access point 901 to the venue 700 in accordance with the principles of the present invention. For example, the automated access point 901 may comprise an automated turnstile 1000 positioned in the entryway 701. The automated turnstile 1000 may comprise a controller 1002 that may be similar in all respects to controller 904. The controller 1002 may be in electronic communication with host device 102 and may control the access restriction mechanism. The turnstile 1000 may comprise a rotator 1010, such as a rotatable tripod, carousel, or other rotatable access prevention structure.

The automated turnstile 1000 may comprise electric motor 1004 that may be similar in all respects to electric motor 1004. Electric motor 1004 may be similar in all respects to electric motor 906. Electric motor 1004 may be in rotary communication with tenon 1006 such that rotation of the electric motor 1004 may dispose the tenon 1006 longer and/or shorter outside the body of the turnstile 1000. The tenon 1006 may engage any of the mortises 1008 of the rotator 1010. When the tenon 1006 is engaged with a mortise 1008, the turnstile 1000 may be prevented from rotating, preventing entry. When the tenon 1006 is not engaged with a mortise 1008, the turnstile 1000 may rotate, allowing entry.

A verification data may comprise a positive or a negative verification. Receipt of a verification data comprising a positive verification by the controller 1002 may result in the controller 1002 causing disengagement of the access restriction mechanism. Upon rotation of the turnstile 1000, the access restriction mechanism may be engaged. Furthermore, the access restriction mechanism may be engaged when the controller 1002 receives a negative verification data, such as from the host device 102.

In some embodiments, the automated access point 901 may comprise the host device 102.

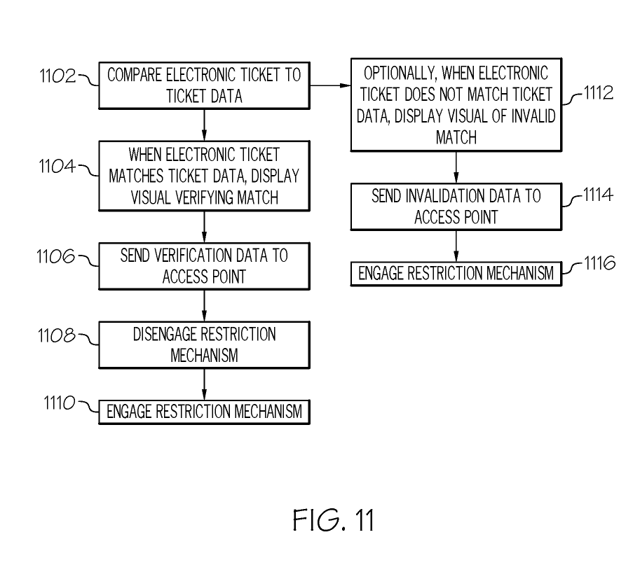

FIG. 11 depicts a block-level diagram of a method of altering the state of a restriction mechanism of an automated access point 901 in accordance with the principles of the present invention.

In accordance with tap verification as described above, the electronic ticket of the client device 104 may be sent to the host device 102. The host device 102 may compare one or more attributes of the electronic ticket received from the client device to one or more attributes of the stored electronic tickets of the ticket data for verification in step 1102. When the electronic ticket is verified a visual verifying the match may be displayed on the host device 102 in step 1104. Step 104 may be optional. The verification data may be sent to the automated access point 901 in step 1106. When the verification data comprises a positive verification, the automated access point 901 may disengage the restriction mechanism in step 1108. This may allow for entry of the bearer of the client device 104 and the verification may be stored in attendee data 703. Upon entry, the restriction mechanism may be engaged in step 1110. For example, entry may be detected by a sensor on the automated access point 901. Examples may include a magnetic switch that closes a circuit once entry is complete.

In optional step 1112, when the electronic ticket is not verified, the host device 102 may display an invalid match visual. The host device 102 may send the negative verification data to the automated access point 1114. In alternative embodiments, the host device 102 may send the corresponding attribute to the automated access point 901. In these embodiments, the automated access point 901 may perform selection of the attribute in locally stored ticket data received from the server 106. Step 1112 is optional, even when proceeding to step 1114. After receipt of the negative verification data, the automated access point 901 may engage the restriction mechanism to prevent entry in step 1116. However, a valid ticket may be later presented, such as after purchase at the point of entry, if provided. In alternative embodiments, after successful selection of the attribute in the ticket data by the automated access point 901, the automated access point may disengage the access restriction mechanism, (e.g. temporarily to allow entry, and then reengaging the access restriction mechanism). In these embodiments, the automated access point 901 may engaged the access restriction mechanism after failed selection by the automated access point 901 of the attribute in the ticket data.

In some embodiments, the automated access point 901 may be wirelessly connected to the server 106. The automated access point 901 may be wirelessly connected with the client device 104. In some embodiments, the connection between the automated access point 901 and the client device 104 may be direct (e.g. without intervening electronic devices), such as via near field communication. The automated access point 901 may store the ticket data and may perform selection of the attribute. In the event of successful selection, the automated access point 901 may disengage the access restriction mechanism. After allowing passage through the automated access point 901, the automated access point 901 may engage the access restriction mechanism. In the event of a failed selection, the automated access point 901 may engage the access restriction mechanism. By way of example, the host device 102 may comprise the automated access point 901.

The client device 104 may be a portable electronic device, such as a smartphone. In this manner, client devices 104 may be carried through the access point 701 to the event venue 700.

The foregoing description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” Similarly, references to an element in the singular in the description mean “one or more” unless specifically stated otherwise. All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method of electronic ticket verification, comprising:
positioning a host device, comprising a screen, a host input interface, and a wireless network adapter, at an access point to a venue at an event time;
verifying, by tap verification, an electronic ticket;
wherein tap verification comprises:
establishing a wireless connection between the host device and a client device;
receiving gesture input through the host input interface;
receiving by the host device an attribute of a client electronic ticket from the client device over the wireless network adapter; and
searching a ticket data for the received attribute.

2. The method of claim 1, further comprising:
finding the attribute in the ticket data; and
displaying a positive visual indicator on the screen after finding the attribute in the ticket data,
wherein the positive visual indicator communicates allowance of entry to a bearer of the client device.

3. The method of claim 2, further comprising:
allowing entry into the venue to the bearer of the client device.

4. The method of claim 1, further comprising:
allowing entry into the venue to the bearer of the client device, wherein allowing entry comprises:
disengaging an access restriction mechanism of an automated access point positioned at the access point of the venue.

5. The method of claim 3, further comprising:
storing an attendee data corresponding an attendee device, wherein the attendee device comprises a client device allowed entry into the venue;
selecting an attendee device; and
sending a payment request to the attendee device.

6. The method of claim 5, wherein the payment request comprises a partial payment request corresponding to partial payment apportioned to the bearer of the attendee device among multiple corresponding bearers of attendee devices.

7. The method of claim 5, further comprising:
receiving a payment authorization from the attendee device; and
sending a payment processing request corresponding to the payment authorization, comprising payment information, to an originator.

8. The method of claim 1, further comprising:
receiving a purchase request from a client device before tap verification.

9. An electronic ticket verifier, comprising:
a host device positioned at an access point to a venue at an event time, the host device comprising a screen, a host input interface, and a wireless network adapter;
wherein the host device is configured to wirelessly connect with a client device at the access point;
wherein the host device is configured to receive a gesture input through the host input interface;
wherein the host device is configured to receive an attribute corresponding to an electronic ticket issued to the client device after wireless connection and receipt of the gesture input; and
wherein the host device is configured to select the attribute in a ticket data.

10. The electronic ticket verifier of claim 9,
wherein the host device is configured to display a positive visual indicator on the screen after successful selection of the attribute in the ticket data,
wherein the positive visual indicator communicates allowance of entry to a bearer of the client device.

11. The electronic ticket verifier of claim 9,
wherein the host device is configured to display a negative visual indicator on the screen after failed selection of the attribute in the ticket data,
wherein the negative visual indicator communicates disallowance of entry to a bearer of the client device.

12. The electronic ticket verifier of claim 9,
wherein the host device further comprises an automated access point comprising an access restriction mechanism; and
wherein automated access point is configured to disengage the access restriction mechanism after successful selection of the attribute in the ticket data.

13. The electronic ticket verifier of claim 12, further comprising:
an automated access point comprising an access restriction mechanism configured to restrict access to the venue through the automated access point when the access restriction mechanism is engaged,
wherein the access restriction mechanism is configured to be disengaged after receipt of the positive verification data by the automated access point such that the venue may be accessed through the automated access point.

14. The electronic ticket verifier of claim 10,
wherein the host device further comprises a near field communication chip, and
wherein initiation of the tap further comprises the host device positioned within at least four centimeters of the client device when the host receives the gesture input.

15. The electronic ticket verifier of claim 9, wherein the host device is configured to send a payment request to an attendee client device.

16. The electronic ticket verifier of claim 9, wherein the host device is configured to accept a partial payment when an amount sent in the payment request is allocated among multiple attendee client devices.

17. The electronic ticket verifier of claim 9, wherein the host device is configured to receive a purchase confirmation corresponding to a client device before the host device is wirelessly connected to the client device.

18. A method of requesting payment, comprising:
selecting an attendee device from an attendee data, the attendee device corresponding to a bearer of the attendee device that is at an event at a venue; and
sending a payment request to the attendee device.

19. The method of claim 18, further comprising:
receiving a payment authorization from the attendee device; and
sending a payment processing request, comprising payment information, to an originator.

20. The method of claim 18, further comprising
receiving a partial payment authorization corresponding to an apportioned cost allocated to the attendee device after allocating an amount requested in the payment request among multiple attendee devices.
